(19) United States
(12) Patent Application Publication
(10) Pub. No.: US 2025/0160240 A1
(43) Pub. Date: May 22, 2025

(54) WORK IMPLEMENTS INCLUDING SUPPORT DEVICES FOR A DRIVELINE AND RELATED COMPONENTS AND METHODS OF USE

(71) Applicant: Alamo Group Inc., Seguin, TX (US)

(72) Inventor: Dawson W. Hastings, Selma, AL (US)

(21) Appl. No.: 18/512,827

(22) Filed: Nov. 17, 2023

(51) Int. Cl. A01B 71/06

(52) U.S. Cl. CPC A01B 71/066

(57) ABSTRACT

A work implement including a driveline configured for connecting to a PTO of a vehicle may include a draft tongue having an aperture for receiving a hitch pin. A driveline support may include a support configured for receiving the driveline when the support is positioned in a working position. The support may include a guide providing a detent for positioning the driveline such that the aperture is unobstructed by the driveline and accessible to receive the hitch pin. The driveline support may further include a height-adjustment bar pivotably mounted to the work implement. The support may be connected to the height-adjustment bar so as to set a height of the support by rotation of the height-adjustment bar. Related methods are also disclosed.

### CROSS REFERENCE TO RELATED APPLICATIONS

None.

### FIELD

This disclosure generally relates to work implements of the type having a driveline for coupling to a power take off (PTO) of a powered vehicle, devices configured for supporting drivelines when coupling such work implements to powered vehicles, and to related methods of use.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

It is common for work implements such as those used for agricultural purposes to include a driveline for coupling to the PTO of a powered vehicle so as to provide a source of power for the implement. Such drivelines are typically mounted in such a way so as to accommodate different powered vehicles (e.g., vehicles of different sizes or models) such as may provide a PTO at different vertical heights. For example, in one exemplary embodiment, a work implement may be a rotary cutter and the powered vehicle may be a tractor. The rotary cutter may include a driveline pivotably mounted to the cutter's frame so that the driveline is adjustable so as to accommodate different styles of tractors or other towing vehicles including a PTO.

For some work implements, a support or driveline holder may be used to support and prevent unwanted movements of the driveline when storing the driveline when not in use or when securing the driveline to the PTO of a powered vehicle. Unfortunately, the support or driveline holders may not be configured to support the driveline in an easy position for hitching the work implement to some vehicles. For example, some existing support or driveline holders used with some rotary cutters may, when used with some tractors, require an operator to lift the driveline, supporting its weight, as they move the driveline to a position enabling them to connect a hitch pin through a hitch's apertures or slots. Alternatively, a separate stand may sometimes be used to support the driveline while an operator is engaged in hitching the cutter to the tractor. The operator may then be tasked with placing the driveline back on the support or driveline holder so that the driveline is supported when aligning and securing the driveline to the tractor's PTO.

It would be advantageous to provide work implements including a support device for a driveline wherein such support devices are not only configured to help align the driveline for coupling to the PTO of a powered vehicle but also to allow an operator to more easily rotate or move the driveline to a position wherein it does not obstruct mounting of the hitch pin to securing apertures or slots of the work implement and powered vehicle.

### SUMMARY

In some embodiments, a work implement including a driveline configured for connecting to a PTO of a powered vehicle may include a frame including a draft tongue having an aperture configured for receiving a hitch pin for hitching the work implement to the powered vehicle and a driveline support. The driveline support may be pivotable between a stowed position and a working position. The driveline support may include a support including a surface configured for receiving the driveline when the driveline support is positioned in the working position. The support may include a guide for positioning the driveline at a first position such that the aperture of the draft tongue is unobstructed by the driveline and accessible to receive the hitch pin. A height-adjustment bar may be pivotably mounted to the frame, the support being connected to the height-adjustment bar so as to set a height of the support by rotation of the height-adjustment bar. The driveline may be positionable in a second position on the support such that the driveline is connectable to and disconnectable from the PTO.

In some embodiments, a driveline support may be configured for supporting a driveline of a work implement when connecting the driveline to a PTO of a powered vehicle. The driveline support may include a support including a first portion and a second portion, the support including a surface configured for receiving the driveline of a work implement when the driveline support is positioned in a working position. The driveline support may further include a guide connected to the second portion of the support, the guide providing a detent for positioning the driveline at a first position wherein the driveline is not aligned with the PTO and does not obstruct a hitch pin aperture of the work implement. The driveline support may further include a height-adjustment bar pivotably mounted to the work implement, the first portion of the support being connected to the height-adjustment bar so as to set a height of the support by rotation of the height-adjustment bar. The driveline is positionable in a second position on the support such that the driveline is aligned with and connectable to and disconnectable from the PTO.

In some embodiments, a method of connecting a work implement to a powered vehicle is provided, the work implement having a driveline and a pivotable driveline support and a draft tongue having an aperture, and the powered vehicle having a PTO. The method may include raising the pivotable driveline support from a stowed position to a working position in which the driveline rests on a surface of the driveline support; moving the driveline to a first position on the surface wherein the aperture of the draft tongue is unobstructed by the driveline; installing a hitch pin in the aperture of the draft tongue and a corresponding aperture of a drawbar of the powered vehicle; moving the driveline to a second position on the surface wherein the driveline is aligned with the PTO; and connecting the driveline to the PTO.

In some embodiments, a work implement may include a driveline configured for connecting to a PTO of a powered vehicle. The work implement may include a frame and a driveline support. The frame may include a draft tongue including an aperture for receiving a hitch pin when hitching the work implement to the powered vehicle. The driveline support may be pivotable between a stowed position and a working position. The driveline support may include a support, a guide, and a height-adjustment bar. The support may include a first end and a second end, the support including a surface configured for receiving the driveline when the driveline support is positioned in the working position. The guide may be connected to the second end of the support, the guide providing a seat for positioning the driveline at a first position configured for facilitating ease of hitching of the work implement to the powered vehicle, the driveline including an outer contour that does not intersect with an axis aligned over the aperture and projecting in a vertical direction from the aperture when the driveline is in the first position. The height-adjustment bar may be pivotably mounted to the frame for rotation about one or more pivots. The support may be configured for connection to the height-adjustment bar at the first end of the support so as to set the height of the support by rotation of the height-adjustment bar.

In some embodiments, a work implement may include a driveline configured for connecting to a PTO of a powered vehicle. The work implement may include a frame and a driveline support. The frame may include a draft tongue including a socket for receiving a hitch ball when hitching the work implement to the powered vehicle. The driveline support may be pivotable between a stowed position and a working position. The driveline support may include a support, a guide, and a height-adjustment bar. The support may include a first end and a second end, the support including a surface configured for receiving the driveline when the driveline support is positioned in the working position. The guide may be connected to the second end of the support. The guide may provide a seat for positioning the driveline at a first position so as to provide an open space above the socket when hitching the work implement to the powered vehicle. The height-adjustment bar may be pivotably mounted to the frame for rotation about one or more pivots. The support may be configured for connection to the height-adjustment bar at the first end of the support so as to set a height of the support by rotation of the height-adjustment bar.

### BRIEF DESCRIPTION OF THE DRAWINGS

FIG. 1 is a perspective view of an exemplary embodiment of a driveline support mounted to the frame of a work implement and in a position used for coupling of the driveline to the PTO of a powered vehicle. The perspective view of FIG. 1 is taken from the left-side of the powered vehicle.

FIG. 2 is a perspective view of the driveline support of FIG. 1 shown in a stowed position.

FIG. 3 is a detailed perspective view of the driveline support of FIG. 1 oriented in a position used for coupling of the driveline to the PTO of a powered vehicle. The perspective view of FIG. 3 is taken from the left-side of the powered vehicle.

FIG. 4 is a detailed perspective view of the driveline support of FIG. 1 oriented in a position used for coupling of the driveline to the PTO of a powered vehicle. The perspective view of FIG. 4 is taken from the right-side of the powered vehicle.

FIG. 5 is a side elevation view of an exemplary embodiment of a height-adjustment bar.

FIG. 6 is a detailed perspective view of the driveline support of FIG. 1 in a stowed position. The perspective view of FIG. 6 is taken from the left-side of the powered vehicle. In FIG. 6, an outline of the height-adjustment bar as it may be positioned in a working orientation is shown as a dashed line so as to help clarify how the height-adjustment bar may move during the rotation R₁.

FIG. 7 is a top plan view of the driveline support of FIG. 1 mounted to the frame of a work implement and oriented in a position for supporting the work implement's driveline and for allowing an operator to hitch the work implement to a powered vehicle.

FIG. 8 is a perspective view of the driveline support of FIG. 1 oriented as in FIG. 7.

FIG. 9 is a top plan view of the driveline support of FIG. 1 connected to a powered vehicle.

FIG. 10 is a schematic cross-sectional view of the driveline and driveline support taken at section 10-10 shown in FIG. 7.

FIG. 11 is a schematic top plan view illustration of an exemplary embodiment of a work implement's driveline shown in relation to other components of the work implement and a driveline support.

FIG. 12 is a flowchart of a method for connecting a work implement to a powered vehicle.

FIG. 13 is a schematic side elevation view illustration of an exemplary embodiment for a driveline as supported during coupling to a powered vehicle.

FIG. 14 is another schematic side elevation view illustration of an exemplary embodiment for a driveline as supported during coupling to a powered vehicle.

FIG. 15 is a flowchart of another method for connecting a work implement to a powered vehicle.

FIG. 16 is a perspective view of another embodiment of a work implement, the work implement including a hitch assembly of a ball-and-hitch type.

FIG. 17 is a perspective view of another embodiment of a driveline support.

### DETAILED DESCRIPTION

As used herein, the following terms should be understood to have the indicated meanings:

When an item is introduced by “a” or “an,” it should be understood to mean one or more of that item.

“Comprises” means includes but is not limited to.

“Comprising” means including but not limited to.

“Having” means including but not limited to.

This disclosure is directed to devices used to assist in the positioning of drivelines when coupling the driveline to a PTO of a powered vehicle and to related components and methods of use. In some embodiments, such devices, generally referred to herein as driveline supports, may include a removable attachment so that the driveline support may be secured to a work implement and removed when not in use. In some embodiments, a driveline support device may be fixedly secured to the work implement and comprise a component of the work implement. The driveline support devices as described herein may be configured not only to help align a work implement's driveline for coupling to the PTO of a powered vehicle but also to support the driveline when it is moved to a position that enables an operator to easily hitch the work implement to a powered vehicle.

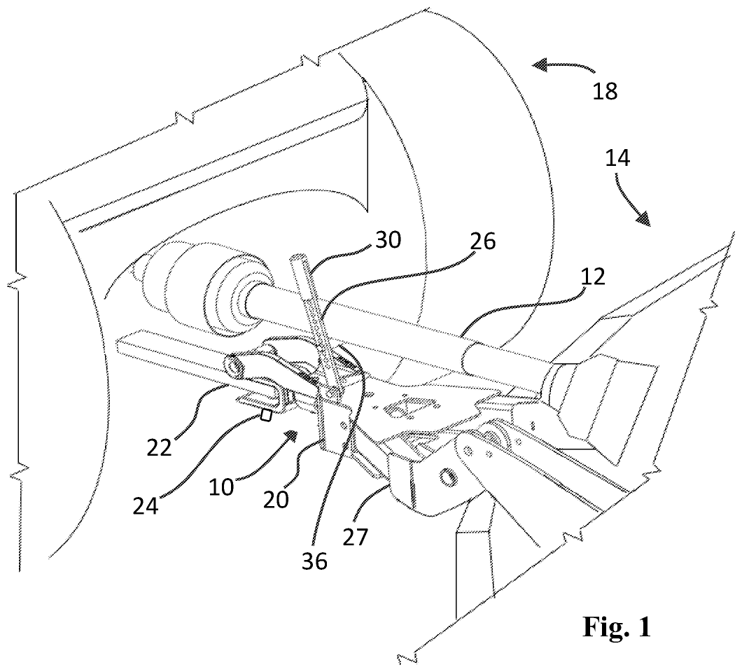

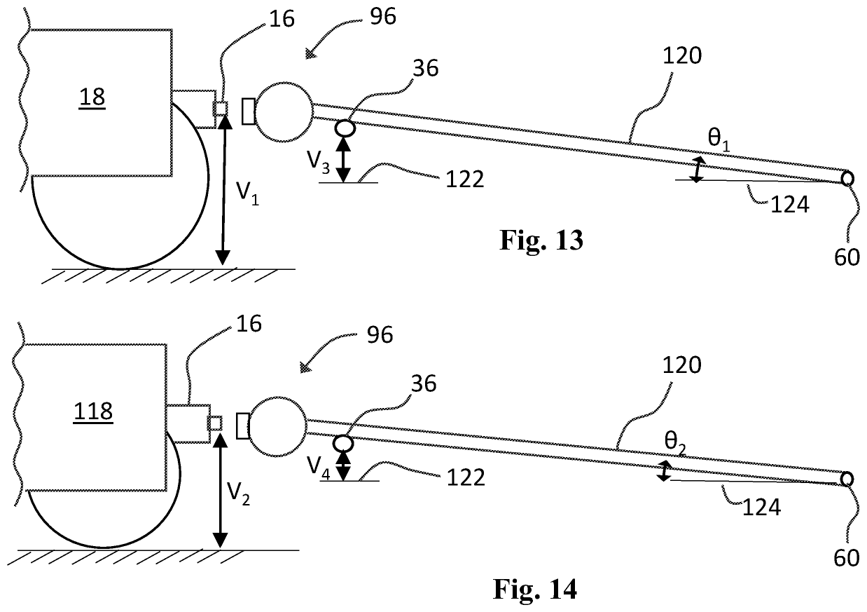

FIG. 1 shows a perspective view of an exemplary embodiment of an adjustable driveline support 10. In FIG. 1, the driveline support 10 is shown in a position engaged with the driveline 12 of a work implement 14 and still in place after the driveline has been secured to the PTO 16 (shown in FIG. 13 and FIG. 14, for example) of a powered vehicle 18. Thus, the driveline support 10 is shown adjusted to a position wherein the driveline 12 is supported at a vertical height and orientation used for establishing the connection of the driveline 12 to the PTO 16.

The driveline support 10 may be connected to the frame 27 of the work implement 14 such as using the work implement's draft tongue 20, for example. In FIG. 1, the draft tongue 20 of the work implement 14 is shown connected to the drawbar 22 of the powered vehicle 18, which in this exemplary embodiment is a tractor. Particularly, the draft tongue 20 is connected to the vehicle's drawbar 22 using a hitch pin 24. While the powered vehicle 18 is shown in an exemplary manner as a tractor, other suitable vehicles equipped with a PTO may also be used. Work implement 14 may, for example, be a rotary cutter such as a flex-wing cutter. However, driveline supports as described herein may also be used with other types of work implements including, but not limited to, agricultural implements such as mowers, tillers, and bailers, for example.

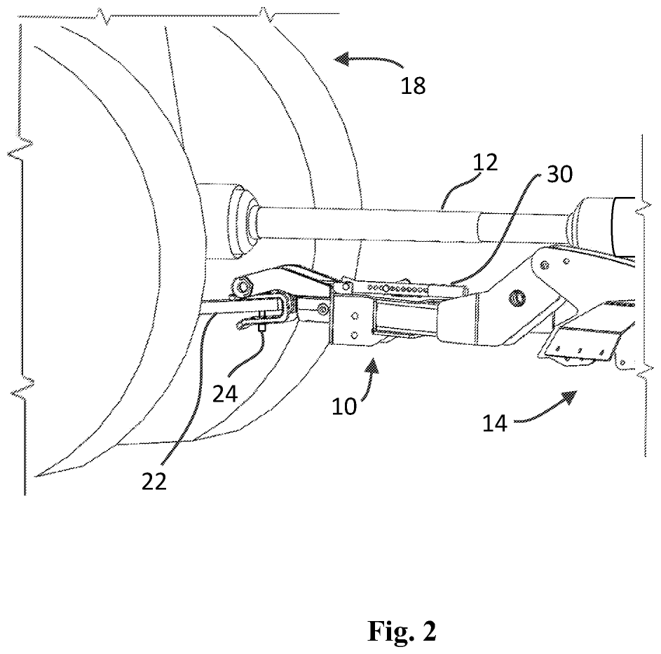

In FIG. 1, driveline support 10 is shown mounted to the frame 27 of the work implement 14 (through the draft tongue 20) and supporting the driveline 12 of the work implement 14 in a position after coupling of the driveline 12 to the PTO 16 of the powered vehicle 18. For example, with the driveline 12 supported in a position adjacent to the PTO, an operator may align the relative splines of the driveline 12 and PTO 16, translate the driveline 12 forward for engagement with the PTO 16, and lock a supporting collar in place to secure the driveline 12 and PTO 16 together. With the driveline 12 of the work implement 14 secured to the PTO 16 of the powered vehicle 18, the adjustable driveline support 10 may be moved from its supporting position shown in FIG. 1 to a non-use or stowed position. For example, in the non-use or stowed position shown in FIG. 2, the driveline support 10 has been rotated so that it is no longer engaged with the driveline 12.

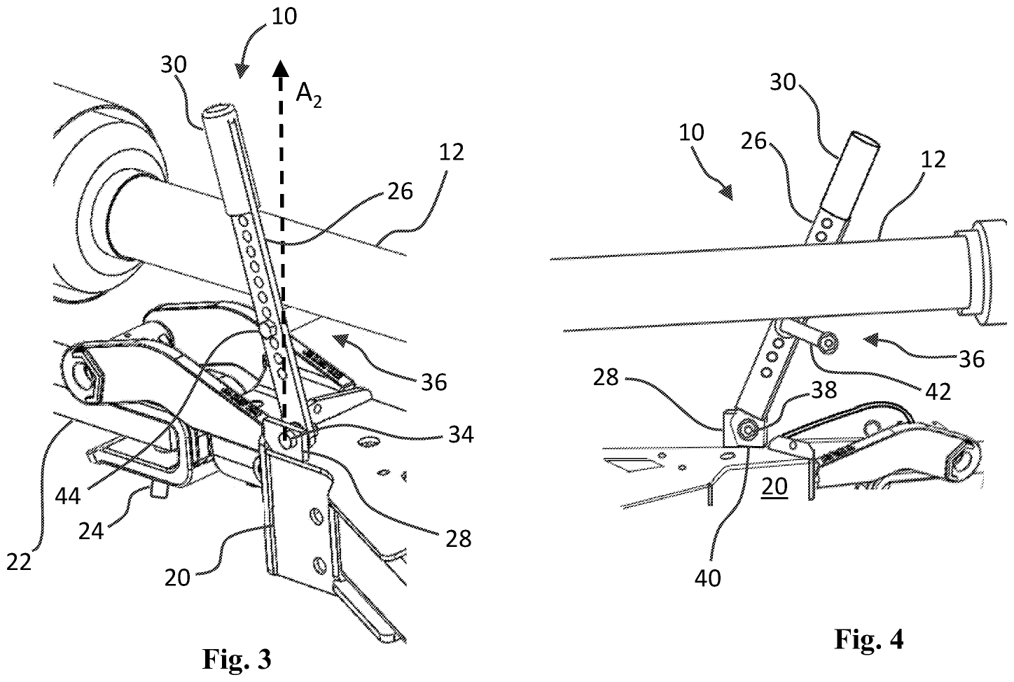

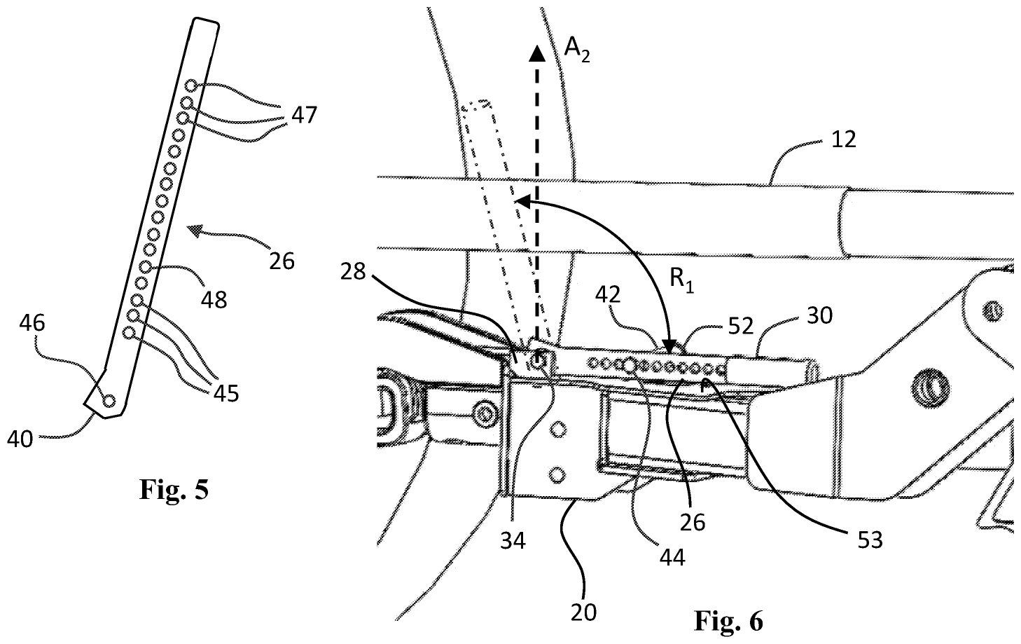

Driveline support 10 is shown in greater detail in FIG. 3 and FIG. 4. FIG. 3 shows a detailed perspective view of the driveline support 10 positioned as shown in FIG. 1, supporting the driveline 12 and connected to the draft tongue 20 of the work implement 14. FIG. 4 shows a perspective view of the driveline support 10 as positioned in FIG. 1 but from the opposite side shown in FIG. 3. Particularly, FIG. 3 shows the driveline support 10 from the left side of powered vehicle 14. FIG. 4 shows the driveline support 10 from the right side of powered vehicle 14. However, in some embodiments, the driveline support 10 may be positioned on either side of the draft tongue 20. As shown in each of FIG. 3 and FIG. 4, the driveline support 10 may include a height-adjustment bar 26 pivotably secured to the draft tongue 20 of the work implement 14. An exemplary embodiment of height-adjustment bar 26 is also shown in FIG. 5. As shown therein, the height-adjustment bar 26 may include a stop 40, a pivot opening 46, and a plurality of spaced height-adjustment apertures 48. In some embodiments, a handle 30 may be secured to the height-adjustment bar 26 to facilitate ease of gripping and adjustment of the driveline support 10. For example, an operator may grip the handle 30 when rotating the driveline support 10 between the support position (shown in FIGS. 1, 3, and 4, for example) and the stowed position (shown in FIG. 2 and FIG. 6, for example).

In some embodiments, driveline support 10 may be secured to the frame 27 of the work implement 14 through its draft tongue 20. For example, the driveline support 10 may be fixedly secured or removably secured to draft tongue 20 through a mount or bracket 28. In the illustrated embodiment shown in FIG. 3 and FIG. 4, the bracket 28 is fixedly connected to the draft tongue 20 using a weldment. Alternatively, the bracket 28 may be connected to the draft tongue 20 using one or more bolts, rivets, or clips, for example. The bracket 28 may provide a groove, slot, or opening for mounting a pivot 34. Pivot 34 may, for example, include a pivot pin or rod coupling the bracket 28 to the height-adjustment bar 26. For example, pivot 34 may extend through one or more openings or slots formed in the bracket 28 and through the pivot opening 46 of the height-adjustment bar 26. One or more bearings may be used to help facilitate pivoting motion of the height-adjustment bar 26 about the pivot 34. In some embodiments, bracket 28 may be connected to or formed as part of a mounting plate, which itself may be fixedly or removably connected to the draft tongue 20 of the work implement 14. In some embodiments, the driveline support 10 may be secured to the frame 27 of the work implement 14 using a removable mount. For example, a driveline support 10 may be secured to the frame 27 of a work implement 14 using a clip. A clip may, for example, be configured so that it may be secured to the draft tongue 20 of a work implement 14 through engagement with one or more flanges.

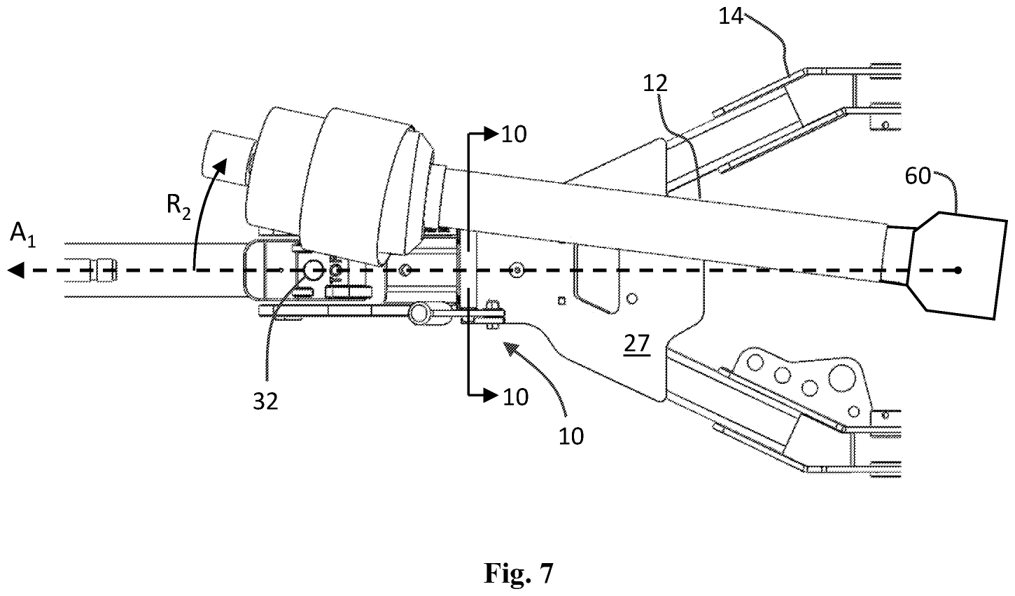

While different structures may be used in some embodiments to mount the driveline support 10 to the frame 27 of the work implement 14, it is an important aspect of some embodiments herein that a driveline support 10 is fixed to the frame 27 of the work implement 14 at a predetermined position relative to an aperture 32 (shown in FIG. 7) configured for receiving the hitch pin 24. For example, as further explained herein, the relative position between the bracket 28 and the opening 32 may be important so that the driveline 12 may be safely moved along the driveline support 10 so as to make it easier for a user to hitch the work implement 14 to the powered vehicle 18.

In some embodiments, the height-adjustment bar 26 may be pivotably mounted to the bracket 28 so that the driveline support 10 may rotate with respect thereto. For example, pivot 34, in the form a pivot pin, may extend through a first opening formed in the bracket 28 and through the pivot opening 46 of height-adjustment bar 26. The pivot 34 may be secured to the bracket 28 and height-adjustment bar 26 using an appropriate fastener, such as a washer and nut 38, for example. The fastener may include or be configured for use with one or more bearings. Of course, any suitable pivotable mounting device may be used to install height-adjustment bar 26 on frame 27. The height-adjustment bar 26 may be pivotably mounted so that a user may rotate the driveline support 10 about the pivot 34. For example, with reference to FIG. 3 and FIG. 6 (which shows a detailed view of the driveline support 10 of FIG. 2), a user may rotate as indicated by R₁ the height-adjustment bar 26 using the handle 30 so that the driveline support 10 is moved about the pivot 34 from the working position shown in FIG. 3 to the stowed position shown in FIG. 6. Likewise, to engage the driveline 12 a user may rotate as indicated by R₁ the height-adjustment bar 26 from a stowed position to a working position. As shown in FIG. 6, the driveline support 10 may sit compactly against the top surface 53 of the draft tongue 20. This may be contrasted with some other driveline supports that may extend a significant distance above the draft tongue 20 when in a stowed position. This may, for example, make it easier to stow the driveline support 10 to a position wherein it does not interfere with operation of some powered vehicles 18, including those with relatively low PTO heights. In another example, driveline supports that fit compactly against the draft tongue 20 may free up the available space above the draft tongue for stowing a hitch jack. In some embodiments, the driveline support 10 may extend no more than about 4 inches to about 2.5 inches above the top surface 53 of the draft tongue 20.

As best shown in FIG. 4, a stop 40 may be provided so as to prevent over-rotation of the driveline support 10 when it has reached its working position. The stop 40 may, for example, comprise a shaped edge formed on either of the height-adjustment bar 26 or the draft tongue 20 of the work implement 14. For example, the driveline support 10 may be rotated to a position beyond the vertical axis A₂ (shown in FIG. 3 and FIG. 6) which is aligned with the pivot 34. Accordingly, the driveline support 10 may be maintained in its working position by a combination of the weight of the driveline 12 resting on a support 36 and engagement between the stop 40 and the frame 27 of the work implement 14.

In some embodiments, the driveline 12 may engage and be supported by the driveline support 10 through the support 36. For example, as a user rotates the driveline support 10 for engagement with the driveline 12, an under surface of the driveline 12 may be received upon a surface of the support 36. In some embodiments, as shown in FIG. 4, the support 36 may be embodied as a roller assembly, such as may include a roller body 42 rotatably mounted to a bushing (not shown). The bushing may, for example, be connected to a securing nut or fastener 44 or any suitable roller connection. Alternatively, the support 36 may be embodied in the form of a pin or other suitable structure. The support 36 may be connected to the height-adjustment bar 26 through the fastener 44. The fastener 44 may be secured in any of the plurality of spaced apart apertures 48 so as to adjust the vertical position of the support 36 when the driveline support 10 is rotated to its working position. For example, by selecting an appropriate aperture among the plurality of spaced apart apertures 48, a user may adjust the vertical position of the support 36 when it is engaged with the driveline 12. Alternatively, the vertical position of the support may be adjusted in another suitable way. For example, in the alternative embodiment of driveline support 100 (shown in FIG. 17), the vertical position of the support 36 may be adjusted using a slidably mounted carriage 106 configured for movement along one or more slide bars 102, 104. Once engaged, the support 36 may allow for adjustment of the driveline 12 in a direction towards the PTO of the powered vehicle 18. For example, the support 36 may comprise a low friction material allowing an operator to slide the driveline 12 in a direction forward towards the PTO of the powered vehicle 18. When the support 36 is embodied as a roller assembly, the driveline 12 may slide forward on the roller assembly towards the PTO of the powered vehicle 18.

As now described with reference to FIGS. 7-11, in some embodiments, the driveline support 10 may be configured so that it may support the driveline 12 when it is moved to a position that enables a user to easily hitch the work implement 14 to the powered vehicle 18. Although description for hitching the work implement 14 to the powered vehicle 18 is sometimes made herein with respect to a cutter and a tractor, driveline supports as described herein may sometimes be used when establishing a hitch connection with other types of work implements and towing vehicles.

Generally, when an operator disconnects a cutter from a tractor, the operator also disconnects the driveline. In such situations, operators commonly rest the driveline on the tongue of the cutter. In this position, the driveline may prevent the user from easily hitching the cutter to the tractor. For example, an operator may be forced to lift up the driveline and support the weight of the driveline when attempting to position the hitch pin into its receiving aperture. While some driveline supports may enable a user to raise the driveline to a level for coupling the driveline to the PTO, this does not always provide the operator with easy access to the draft tongue of the cutter for the purpose of hitching the cutter to the tractor. For example, in some situations, as may depend, for example, on the relative heights of the PTO of the tractor and the driveline 12 or the evenness of the ground, a user may adjust a driveline support to support the driveline at a proper vertical height for coupling to the PTO. However, at this position, the driveline may still block or make it difficult to access the aperture 32. Thus, to both hitch the cutter to the tractor and align the driveline of the cutter to the tractor's PTO, the user may be driven to raise up and support the driveline's weight (when hitching the cutter to the tractor) or support the driveline on a separate stand. Some embodiments herein provide an alternative and easier approach for both hitching or unhitching a tractor to a work implement and securing or disconnecting the driveline of the work implement to the PTO of the tractor for powered communication therebetween.

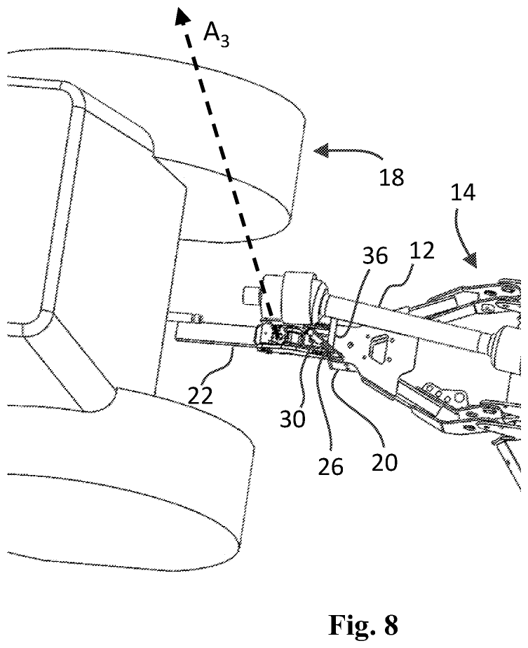

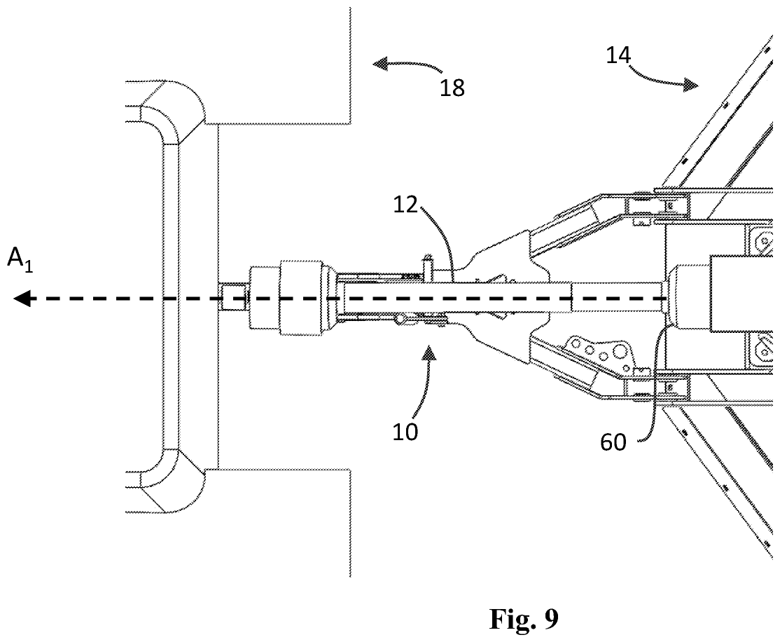

FIG. 7 shows a top plan view of the driveline support 10 in a position supporting the driveline 12 of the work implement 14. FIG. 8 shows a perspective view of the driveline support 10 as positioned in FIG. 7. In FIG. 7 and FIG. 8, the driveline 12 has been moved or rotated as shown by R₂ about its connecting joint 60 so that the driveline 12 is positioned so as to enable a user to easily hitch or unhitch the work implement 14 to the powered vehicle 18. In the top plan view shown in FIG. 7, the aperture 32 is clearly visible when the driveline 12 is rotated as shown. This configuration may be contrasted with the top plan view shown in FIG. 9, for example. As shown therein, the driveline 12 may be generally aligned so that its longitudinal axis A₁ is positioned in line with the vehicle's PTO as is necessary when connecting the PTO to the driveline. In the orientation of FIG. 9, the aperture 32 is hidden underneath the driveline 12 with the driveline 12 generally blocking or making access to the aperture 32 difficult. By rotating the driveline 12 as shown in FIG. 7 and FIG. 8, a user has a clear path for inserting the hitch pin 24 into aperture 32. In FIG. 8, a vertical axis A₃ is shown. The vertical axis A₃ is centered on the aperture 32. With the driveline 12 positioned as shown in FIG. 7 and FIG. 8, the vertical axis A₃ extends past the driveline 12 without intersection therewith. Thus, a user may insert the hitch pin 24 through the aperture 32 by simply aligning the hitch pin 24 along the axis A₃ and moving the hitch pin 24 downwards for engagement with the aperture 32 and a corresponding aperture of drawbar 22 to hitch the work implement 14 to powered vehicle 18, and the user may easily withdraw the hitch pin 24 from those apertures to unhitch the work implement 14 from the powered vehicle 18.

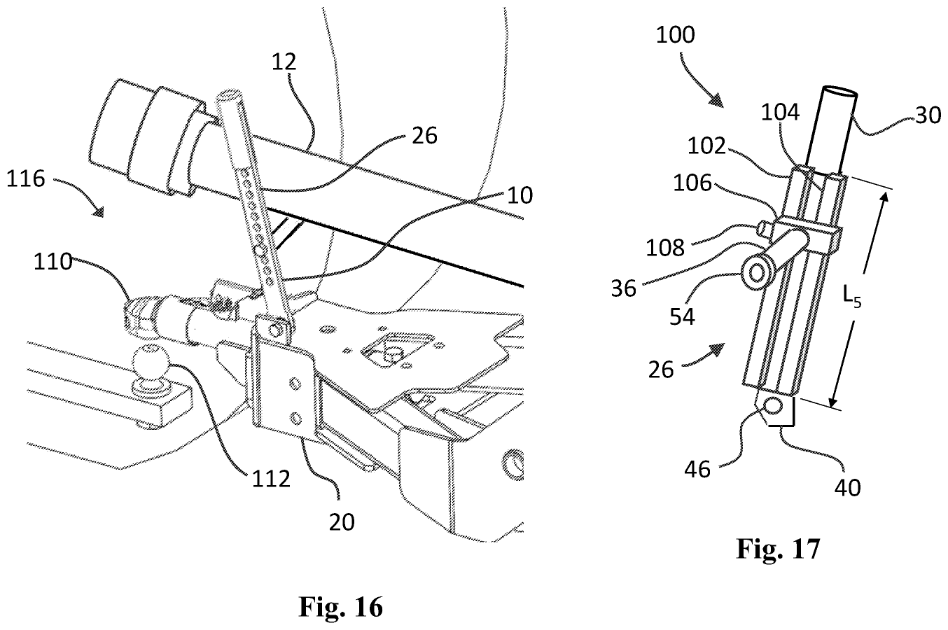

As described above, in some embodiments, a driveline support 10 may be configured to assist a user when hitching a work implement 14 to a powered vehicle 18. For example, as shown in FIGS. 7-9, an operator may rotate the driveline 12 as shown by R₂ about its connecting joint 60 so that the driveline 12 is positioned so as to help a user to work with a hitch assembly of a type wherein a hitch pin 24 is mounted through the aperture 32 and a corresponding aperture of drawbar 22. However, it should be understood that certain advantages for using the driveline support 10 extend to different types of hitch assemblies, including, by way of nonlimiting example, ball-and-hitch type assemblies and hook and ring type assemblies. For example, FIG. 16 shows an exemplary embodiment of a work implement 14 configured for use with a hitch assembly of a ball-and-hitch type. As shown therein, in some embodiments, the work implement 14 may include a hitch in the form of a socket 110. The socket 110 may be configured for engaging with a hitch ball 112 as may be included in some embodiments of powered vehicle 18. The driveline support 10 may be used to rotate the driveline 12 so as to provide an open or free space 116 above the socket 110. An operator may, for example, work in this open or free space 116 after initial engagement between the socket 110 to the hitch ball 112 and when locking the hitch assembly in place. This may, for example, commonly involve using one or more chains or a locking mechanism to secure the hitch assembly. The driveline support 10 may also hold the driveline 12 in place when an operator uses a jack assembly (not shown) to raise and/or lower the hitch assembly. For example, in some embodiments, work implement 14 may include a jack assembly removably or fixedly connected to the work implement's frame 27. For example, the jack assembly may be secured on either of a left side or right side of the draft tongue 20 of the work implement 14. Advantageously, in some embodiments, the driveline 12 may be positioned (e.g., on either the left or right side of the work implement 14) so as to enable rotation of the driveline 12 in a direction away from the jack assembly. For example, the driveline support 10 may be used to rotate the driveline towards the right side of the powered vehicle 18, and the jack assembly may be secured to the left side of the powered vehicle. The driveline 12 may thus be conveniently oriented to the opposite side of the hitch assembly when a user cranks or rotates a handle of the jack assembly when raising or lowering the hitch assembly. Notably, the driveline 12 may compactly fit against the draft tongue 20 when in a stowed position. This may be advantageous when the jack assembly is stowed together with the driveline 12 against the draft tongue 20.

Referring back to the exemplary embodiment of a hitch assembly as shown in the illustrated embodiment in FIGS. 7-9, once the hitch pin 24 has been inserted through the aperture 32, the user may rotate the driveline 12 so that it is aligned with the PTO and translate the driveline 12 forward so as to establish a powered connection to the powered vehicle 14. For example, as shown in FIG. 9, the driveline 12 may be aligned generally so that its longitudinal axis A₁ is positioned in line with the vehicle's PTO. Using the support 36, the user may translate the driveline 12 forwards without having to support the weight of the driveline 12.

In some embodiments, the support 36 may have an outer surface that provides a relatively low coefficient of friction between the driveline 12 and the outer surface. For example, in some embodiments, the outer surface of the support 36 may be made of or include a fluoropolymer such as polytetrafluoroethylene (PTFE). Thus, a user may relatively easily slide the driveline 12 along the driveline support 10 when it is rotated to provide easier access for the hitch connection and/or when moving the driveline 12 forward when engaging the driveline 12 with the PTO. In some embodiments, support 36 may be embodied as a roller assembly so that the driveline 12 may slide forward on the roller assembly when the operator is connecting the driveline 12 to the PTO, and driveline 12 may slide rearward on the roller assembly when the operator disconnects the driveline 12 from the PTO.

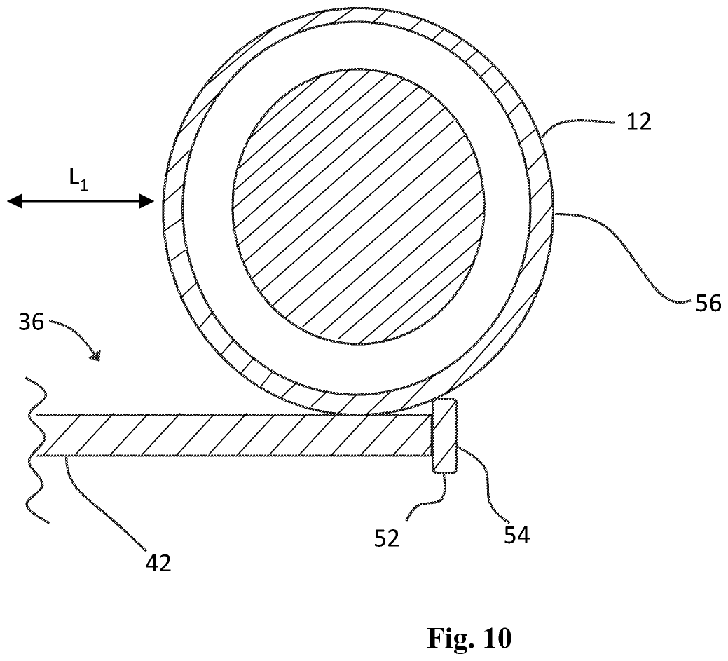

FIG. 10 is a schematic cross-sectional view of driveline 12 and support 36 of driveline support 10 taken at section 10-10 shown in FIG. 7. As shown therein, in some embodiments, the support 36 may include a guide 52. The guide 52 may act as a lateral stop so that the driveline 12 cannot easily slide over the distal end 54 of the support 36 at least without lifting the driveline 12 over the guide 52. The guide 52 may further act to set the position of the driveline 12 so that when the driveline 12 is engaged with the guide 52, clearance is provided above the aperture 32 for insertion of the hitch pin 24. For example, in some embodiments, to guarantee clearance of the hitch pin 24 for insertion into the aperture 32, an operator may simply slide the driveline 12 laterally along the roller body 42 as indicated by L₁ until it meets up against the guide 52 as shown in FIG. 10.

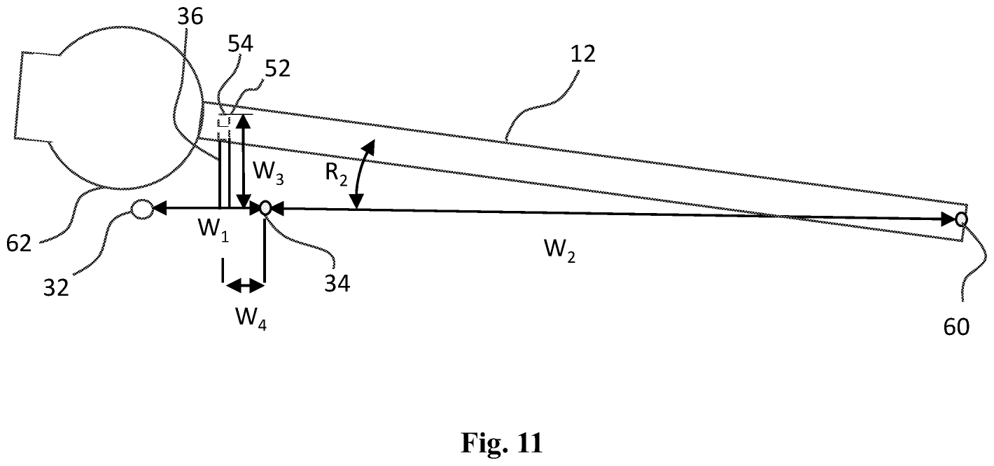

In some embodiments, when engaged or seated against the guide 52, the driveline 12 is configured so that a substantial portion of the driveline 12 is positioned past the distal end 54 of the support 36. For example, as shown in FIG. 10, the outer edge 56 of the driveline 12 may extend past the distal end 54 of the support 36. In some embodiments, the guide 52 may provide a detent mechanism so that an operator may easily set the position of the driveline 12 in a cleared position above the aperture 32 while generally minimizing a length of the support 36. For example, when seated against the guide 52, the driveline 12 may be stably supported by the support 36. The support 36 may include a length W₃ (shown in FIG. 11, for example) suitable for positioning the guide 52 to its intended position as described above. The length W₃ may be sufficiently short, or the bending stiffness of support 36 may be sufficiently large, so that the support 36 may not bend to such an extent that the driveline 12 might slide past the guide 52 and fall off the support 36. For example, in some embodiments, the length W₃ may be about 5 inches to about 8 inches.

FIG. 11 shows a schematic top plan view illustration of the driveline 12 of work implement 14 in relation to other components of the work implement and/or driveline support 10. With reference thereto, in some embodiments, the support 36 may be positioned to a predetermined position in relation to the hitch pin's aperture 32 when the support 36 is secured through a selected aperture among the plurality of spaced apertures 48 on height-adjustment bar 26 and the driveline support 10 is rotated (see R₁ as shown in FIG. 6) to a position for supporting the driveline 12. The driveline support 10 may be pivotally mounted to the frame 27 of the work implement 14. For example, the pivot 34 may be fixedly secured on the frame 27 through bracket 28, generally, at a position between the joint 60 of the driveline 12 and the aperture 32 (for receiving the hitch pin 24) of the draft tongue 20. For example, bracket 28 may be welded to the frame 27 of the work implement 14 on the draft tongue 20. In FIG. 11, the pivot 34 is shown displaced from the aperture 32 by the distance W₁. The pivot 34 is shown offset from the joint 60 of the driveline 12 by the distance W₂. The support 36 is shown slightly offset from the pivot 34 (shown as W₄ in FIG. 11). For example, as explained herein in relation to FIG. 6, the support 36 may be rotated as shown at R₁ until the stop 40 engages the frame 27 of the work implement 14 so that support 36 is held in a position that is slightly beyond (forward of) the vertical axis A₂.

As shown in FIG. 11, the support 36 may have a length W₃. For example, in some embodiments, the length of the roller support 36 may be about 5 inches to about 8 inches (about 12.7 cm to about 20.3 cm). As shown in FIG. 11, the driveline 12 may be rotated as shown by R₂ until it is generally seated against the guide 52. As shown by the dashed portion of the support 36 (which shows guide 52 disposed underneath the driveline 12), the driveline 12 may seat against the guide 52 so that at least a portion of the driveline 12 extends laterally beyond the distal end 54 of the support 36. When positioned against the guide 52, the driveline 12 is shifted away from the aperture 32. In this position an outer contour 62 of the driveline 12 is shifted away from the aperture 32. In this orientation, as shown in both FIG. 7 and FIG. 11, the hitch pin 24 may be freely inserted through aperture 32 and a corresponding aperture of drawbar 22 without obstruction when positioned in a vertical orientation above the aperture 32 and moved straight downwards for engagement with the apertures while the driveline 12 remains supported by the support 36.

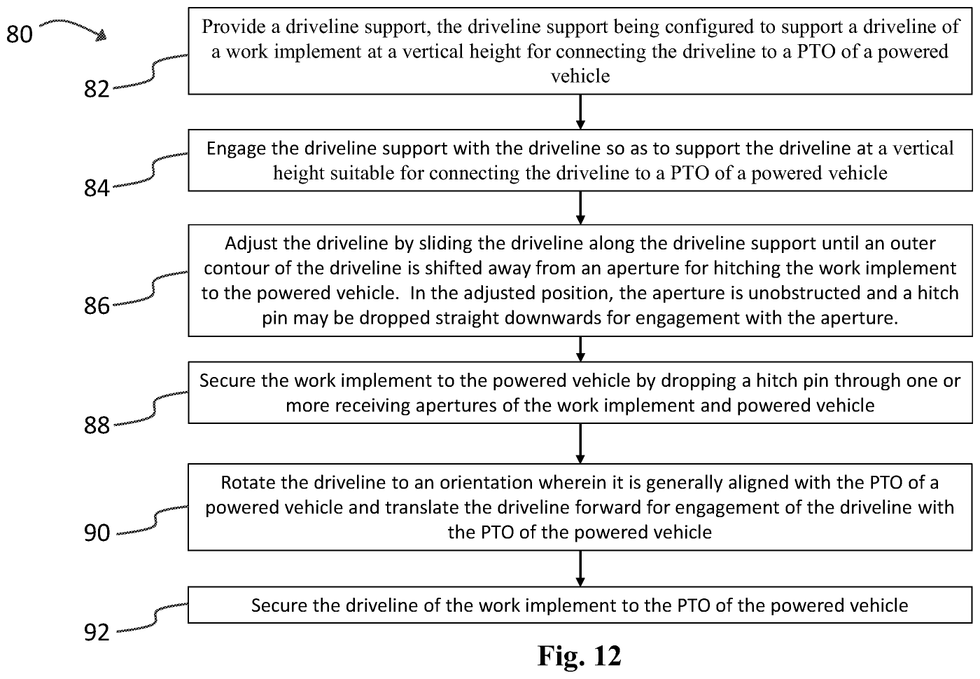

An exemplary method 80 for connecting a work implement 14 to a powered vehicle 18, 118 is shown in FIG. 12. In execution of the method 80, the work implement 14 may be both hitched to a powered vehicle 18, 118 and a connection for receiving power from the vehicle may be established. In some embodiments, the power connection between the work implement 14 and the powered vehicle 18, 118 may be established or disconnected without having to change the position of a support 36 along the height-adjustment bar 26. Likewise, the power connection between the work implement 14 and powered vehicle 18, 118 may be established or disconnected without relying on a separate support stand. At step 82, a driveline support may be provided, the driveline support being configured to support a driveline of a work implement at a vertical height for connecting the driveline to a PTO of a powered vehicle. For example, a driveline support 10 may be provided for use. The driveline support 10 may include a support 36 secured to a particular aperture included among a plurality of spaced apart apertures 48 of a height-adjustment bar 26. When rotated (R₁) to a working position, the driveline support 10 may engage with and support the driveline 12 at a vertical height for coupling the driveline to a PTO of a powered vehicle 18. At step 84, the driveline support may be engaged with the driveline so as to support the driveline at a vertical height for connecting the driveline to a PTO of a powered vehicle. For example, the driveline support 10 may be rotated (R₁) to a working position engaged with the driveline 12. Alternatively, an operator may begin a procedure for securing a work implement 14 to a powered vehicle 18 with the driveline already engaged at a vertical height for coupling the driveline to a PTO of a powered vehicle 18.

As shown at step 86, the driveline 12 may be adjusted by sliding the driveline 12 along the support 36 until an outer contour of the driveline is shifted away from an aperture for hitching the work implement 14 to the powered vehicle 18, 118. For example, as shown in FIG. 11, driveline 12 may be rotated (R₂) to a position wherein the outer counter 62 of the driveline 12 is separated or offset from the aperture 32 such that aperture 32 is unobstructed. In this position, the hitch pin 24 may be dropped straight downwards for engagement with aperture 32 of the work implement 14. Alternatively, as may be the case for some embodiments (see FIG. 16), when rotated as shown by R₂, driveline 12 may be oriented so as to provide an open or free space 116 above the socket 110 so that it may be conveniently engaged with the hitch ball 112 and locked in place.

As shown at step 88, the work implement 14 may be secured to the powered vehicle 18 by dropping a hitch pin 24 through the aperture 32 of the work implement 14. As understood in the art, the hitch pin 24 may also engage with an aligned aperture or slot of the powered vehicle (e.g., on the drawbar 22). Other standard operations commonly performed when hitching the work implement to the powered vehicle may also be performed. For example, one or more chains may be secured between the work implement 14 and the powered vehicle 18, 118. Alternatively, with reference to FIG. 16, the work implement 14 may be secured to the powered vehicle 18, 118 using a ball-and-hitch type of assembly or another suitable hitch-assembly may be used.

As shown at step 90, the driveline may be rotated to an orientation wherein it is aligned with the PTO of the powered vehicle. For example, the driveline 12 may be rotated (R₂) so that it is generally aligned along the axis A₁ (as shown in FIG. 9, for example). The driveline 12 may then be translated forward for engagement with the PTO. In step 92, the driveline may be secured to the PTO of the powered vehicle.

As described herein, driveline 12 may include a joint 60. The joint 60 may, for example, include a universal joint (U-Joint) which as understood in the art allows for adjustment of the driveline 12 about multiple axes. In some embodiments, the driveline 12 may further include a constant velocity (CV) joint 96. For example, FIG. 13 is a schematic illustration of an exemplary embodiment of a driveline 120 including a universal joint 60 and CV joint 96. FIG. 13 further shows the driveline 120 held adjacent to PTO 16, which is secured to the powered vehicle 18 at a height V₁ above the ground. The driveline 120 is similar to the driveline 12 except that the driveline 120 is specifically denoted as having a CV Joint 96. For example, whereas driveline 12 may include any suitable joint (of a constant velocity type or otherwise) for coupling to the PTO of a powered vehicle, the driveline 120 includes the CV joint 96.

Either of the drivelines 12, 120 may be adjustable for connecting to different powered vehicles that may provide a PTO connection at different vertical heights. For example, in schematic FIG. 13, the driveline 120 is shown adjusted at an angle θ₁ above a horizontal plane 124 about which the joint 60 articulates. At the angle θ₁, the driveline 120 projects forward so as to seat upon the support 36. Support 36 is itself shown positioned at the adjusted vertical height V₃, above a surface 122 (which, e.g., may be the top surface of the draft tongue 20 upon which driveline support 10 is mounted). FIG. 14 is another schematic illustration of the driveline 120. As shown in FIG. 14, the driveline 120 projects forward from the joint 60 at the angle θ₂. The driveline 120 is shown supported by support 36. Support 36 is adjusted to the vertical height V₄ so as to accommodate the PTO 16 mounted to powered vehicle 118. Powered vehicle 118 may, for example, be similar to powered vehicle 18, except that it provides the PTO 16 at a lower vertical height V₂ as compared to the vertical height V₁ for powered vehicle 18 in FIG. 13. In some embodiments, a work implement 14 including or provided with a driveline support 10 may be configured so that its driveline may be adjusted for connecting to different powered vehicles that may provide PTO connections at different vertical heights. For example, a work implement including or provided with a driveline support 10 may be configured so that its driveline may be connected to different powered vehicles providing PTOs over a vertical height range.

For example, in some embodiments, a work implement 14 including a driveline support 10 may be configured for connection to different powered vehicles providing PTOs over a vertical height range of about 480 mm to about 800 mm, or over some other vertical height range. For example, in some embodiments, a driveline support 10 may be configured for connection to different powered vehicles providing PTOs over a vertical height range specified according to an industry standard. For example, in some embodiments, a driveline support 10 may be configured for connection to different powered vehicles providing PTOs over a vertical height range as specified in an ISO 500 standard.

In some embodiments, to connect a work implement to a powered vehicle with a PTO height of about 480 mm, the driveline support 36 may be secured to one of a group of lower positioned apertures 45 (see FIG. 5). When secured thereto, the driveline 12 may be rotated as shown by R₂ so as to provide a clear pathway (see the axis A₃ shown in FIG. 8) for inserting of the hitch pin 24 through aperture 32 and a corresponding aperture of a drawbar of the powered vehicle. Alternatively, the driveline 12 may be rotated as may be convenient for another type of hitch assembly. For example, the driveline 12 may be moved about the full length L₁ (see FIG. 10) until it meets up against the guide 52. Alternatively, as shown in FIG. 17, the height adjustment bar 26 may be embodied in the form of a slide bar. The slide bar may be sized in length L₅ so that driveline support 36 may be secured towards the lower end of the slide bar and the driveline 12 may be supported thereon and rotated until it meets up against the guide 52.

In some embodiments, the group of lower positioned apertures 45 may include one aperture that is generally configured for use with a PTO provided at a vertical height at a lower end of a vertical height range when a work implement 14 and a powered vehicle 118 are hitched over level ground. One or more other apertures among the group of lower positioned apertures 45 may be configured for use with a PTO at the lower end of the vertical height range when a work implement 14 and a powered vehicle 118 are hitched over uneven ground. For example, the second lowest aperture among the group of lower positioned apertures 45 (shown in FIG. 5) may be configured for use with a PTO with a vertical height at a lower end of a vertical height range when a work implement 14 and powered vehicle 118 are hitched over level ground. However, the lowest aperture among the group of lower positioned apertures 45 may be used when an operator is hitching a work implement 14 to a powered vehicle 188 over uneven ground. Thus, a work implement 14 including or provided with a driveline support 10 may be configured for use with a PTO provided at a vertical height at a lower end of a vertical height range even when used on uneven ground (e.g., a specified grade of terrain over which the work implement 14 may be configured for use).

Likewise, to connect a work implement to a powered vehicle with a PTO height of about 800 mm, the support 36 may be secured to one of a group of higher positioned apertures 47 (see FIG. 5). Alternatively, if the height adjustment bar 26 is embodied as a slide bar (see, e.g., FIG. 17), the slide bar may be sized in length so as to allow a user to move the support 36 along the length of the slide bar as appropriate for connection to the PTO. Again, when secured thereto, the driveline 12 may be rotated as shown by R₂ (see FIG. 7 and FIG. 11) so as to provide a clear pathway (see the axis A₃ shown in FIG. 8) for inserting of the hitch pin 24 through aperture 32 and a corresponding aperture of a drawbar of the powered vehicle. For example, the driveline 12 may be moved about the full length L₁ (see FIG. 10) until it meets up against the guide 52. Of course, in this example, where the work implement is being connected to a PTO at a high vertical position, the operator may sometimes easily insert the hitch pin 24 even without moving the driveline 12 the full length L₁ provided by the support 36. Again, a suitable aperture among the higher positioned apertures 47 may be used based on the relative grade of terrain over which the work implement 14 and powered vehicle 18 are being hitched. Thus, a work implement 14 including or provided with a driveline support 10 may be configured for use with a PTO provided at a vertical height at an upper end of a vertical height range.

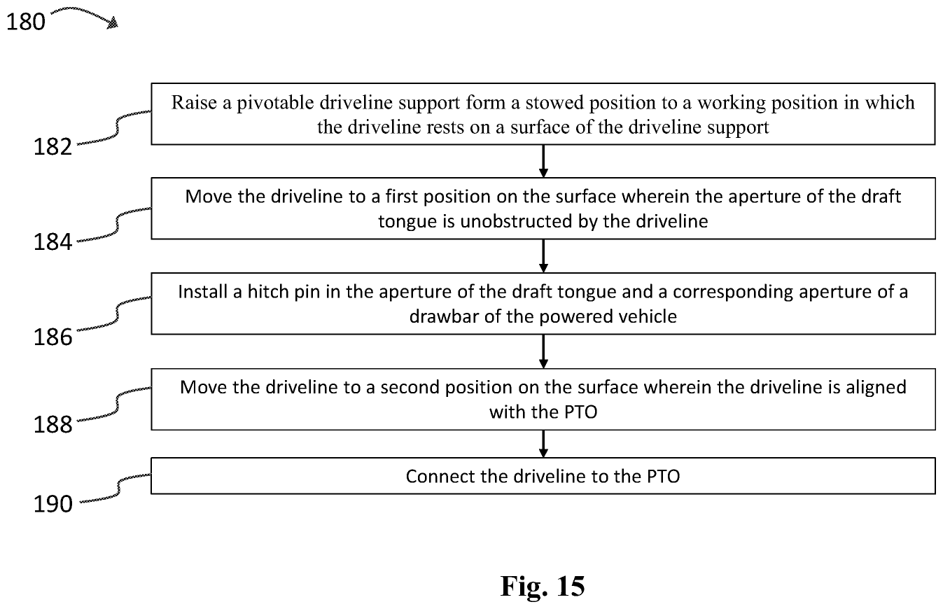

Another exemplary method 180 for connecting a work implement 14 to a powered vehicle 18, 118 is shown in FIG. 15. The work implement 14 may have a pivotable support and a draft tongue having an aperture, and the powered vehicle 18, 118 having a PTO. In step 182, a pivotable driveline support may be raised from a stowed position to a working position in which the driveline rests on a surface of the driveline support. In step 184, the driveline may be moved to a first position on the surface wherein the aperture of the draft tongue is unobstructed by the driveline. In step 186, a hitch pin may be installed in the aperture of the draft tongue and a corresponding aperture of a drawbar of the powered vehicle. In step 188, the driveline may be moved to a second position on the surface wherein the driveline is aligned with the PTO. In step 190, the driveline may be connected to the PTO.

FIG. 17 shows an alternative embodiment of a driveline support 100. As shown therein, in some embodiments, a height adjustment bar 26 may be embodied as a slide bar. The slide bar may, for example, include one or more rails 102, 104. For example, in the illustrated embodiment, the driveline support 100 includes a right-side rail 102 and a left-side rail 104. A carriage 106 may be slidably engaged with the one or more rails 102, 104 through internal bearings (not shown). Support 36 may be attached to carriage 106. Accordingly, the support 36 may be moved continuously along the length of the one or more rails 102, 104 and carriage 106 may be secured at a desired position along rails 102, 104 using a suitable fastener 108, such as a set screw, for example. The one or more rails may, for example, be sized in length L₅ so as to allow for position of the support 36 via carriage 106 over a suitable range to accommodate different powered vehicles 18, 118 such as may provide PTOs at different vertical heights.

Although the foregoing specific details describe certain embodiments of this invention, persons of ordinary skill in the art will recognize that various changes may be made in the details of this invention without departing from the spirit and scope of the invention as defined in the appended claims and other claims that may be drawn to this invention and considering the doctrine of equivalents. Among other things, any feature described for one embodiment may be used in any other embodiment, and any feature described herein may be used independently or in combination with other features. Also, unless the context indicates otherwise, it should be understood that when a component is described herein as being secured, mounted, connected, or coupled to another component, such may be secured, mounted, connected, or coupled, directly with no intermediate components or indirectly with one or more intermediate components. Therefore, it should be understood that this invention is not to be limited to the specific details shown and described herein.

What is claimed is:

1. A work implement including a driveline configured for connecting to a PTO of a powered vehicle, the work implement comprising:
a frame including a draft tongue having an aperture configured for receiving a hitch pin for hitching the work implement to the powered vehicle; and
a driveline support pivotable between a stowed position and a working position, the driveline support comprising:
a support including a surface configured for receiving the driveline when the driveline support is positioned in the working position;
the support further including a guide for positioning the driveline at a first position such that the aperture of the draft tongue is unobstructed by the driveline and accessible to receive the hitch pin; and
a height-adjustment bar pivotably mounted to said frame, the support being connected to the height-adjustment bar so as to set a height of the support by rotation of the height-adjustment bar, wherein the driveline is positionable in a second position on the support such that the driveline is connectable to and disconnectable from the PTO.

2. The work implement of claim 1 wherein the work implement is one of a rotary cutter, a tiller, and a bailer.

3. The work implement of claim 1 wherein the driveline support is fixedly connected to the frame.

4. The work implement of claim 3 wherein the driveline support is fixedly connected to the frame at a predetermined distance from the aperture of the draft tongue.

5. The work implement of claim 4 wherein the predetermined distance is selected so that the driveline of the work implement may be positioned against the guide so that the aperture of the draft tongue is unobstructed and accessible to receive the hitch pin.

6. The work implement of claim 4 wherein the predetermined distance is selected so that the driveline is removably connectable to a PTO of a first powered vehicle and a PTO of a second powered vehicle.

7. The work implement of claim 6 wherein said first powered vehicle is a powered vehicle including a PTO positioned at a minimum vertical height according to an ISO 500 standard.

8. The work implement of claim 1 wherein the support has a length of about 5 inches to about 8 inches.

9. The work implement of claim 1, the driveline support further comprising a stop configured to prevent over-rotation of the height-adjustment bar.

10. The work implement of claim 1 further comprising a bracket configured for mounting the height-adjustment bar to the frame.

11. The work implement of claim 10 wherein the bracket comprises a slot for mounting a pivot, the height-adjustment bar being mounted to said pivot.

12. The work implement of claim 1 wherein the support comprises a roller assembly comprising a roller body mounted to a bushing.

13. The work implement of claim 12 wherein the driveline rests on the roller body and the guide prevents the driveline from sliding off of the roller body without a user lifting the driveline over the guide.

14. The work implement of claim 13 wherein a substantial portion of the driveline extends over the guide when the driveline is in the first position.

15. The work implement of claim 1 wherein a substantial portion of the driveline extends over the guide when the driveline is in the first position.

16. The work implement of claim 1 wherein the support extends about 4 inches to about 2.5 inches above the draft tongue when the driveline support is positioned in the stowed position.

17. The work implement of claim 1 wherein the height-adjustment bar comprises a plurality of apertures, and wherein the support is removably insertable in a selected one of the plurality of apertures.

18. The work implement of claim 1 wherein the support is slidably mounted to the height-adjustment bar.

19. The work implement of claim 18 wherein the height-adjustment bar includes at least one rail and the support extends from a carriage that is slidably mounted to the at least one rail.

20. A driveline support configured for supporting a driveline of a work implement when connecting the driveline to a PTO of a powered vehicle comprising:
a support including a first portion and a second portion, the support including a surface configured for receiving the driveline when the driveline support is positioned in a working position;
a guide connected to the second portion of the support, the guide providing a detent for positioning the driveline at a first position wherein the driveline is not aligned with the PTO and does not obstruct a hitch pin aperture of the work implement; and
a height-adjustment bar pivotably mounted to the work implement, the first portion of the support being connected to the height-adjustment bar so as to set a height of the support by rotation of the height-adjustment bar, wherein the driveline is positionable in a second position on the support such that the driveline is aligned with and connectable to and disconnectable from the PTO.

21. The driveline support of claim 20 wherein the guide prevents the driveline from sliding off of the support without a user lifting the driveline over the guide.

22. The driveline support of claim 21 wherein a substantial portion of the driveline extends over the guide when the driveline is in the first position.

23. The driveline support of claim 20 wherein the support comprises a roller assembly including a roller body mounted to a bushing.

24. The driveline support of claim 20 wherein the height-adjustment bar comprises a plurality of apertures, the support being configured for connection to individual apertures among the plurality of apertures so as to set the height of the support.

25. The driveline support of claim 20 wherein the height-adjustment bar comprises a slide bar, the support being connected to the height-adjustment bar through a carriage slidably mounted thereto.

26-58. (canceled)
